(19) United States
(12) Patent Application Publication
(10) Pub. No.: US 2010/0103794 A1
(43) Pub. Date: Apr. 29, 2010

(54) SCANNING DEVICE HAVING A HOLDING FIXTURE FOR COOLING OF A PICKUP

(76) Inventors: Stephan Knappmann, Zimmern OB Rottweil (DE); Juergen Moessner, Brigachtal (DE)

Correspondence Address: Robert D. Shedd, Patent Operations;THOMSON Licensing LLC, P.O. Box 5312, Princeton, NJ, 08543-5312, US

(21) Appl. No.: 12/449,507

(22) PCT Filed: Feb. 13, 2008
(86) PCT No.: PCT/EP2008/051759

§ 371 Date: Aug. 11, 2009

(30) Foreign Application Priority Data
Feb. 15, 2007 (EP) 07102469.9

(51) Int. Cl. G11B 7/00

(52) U.S. Cl. 369/100; G9B/7

(57) ABSTRACT

The device comprises a scanning apparatus with a pickup for reading and/or recording data on a storage medium, a holding fixture for providing a parking position for the scanning apparatus, and a magnetic drive actuator for a movement of the scanning apparatus, wherein the holding fixture comprises a heat sink for cooling down the pickup. The scanning apparatus is in particular of a swing arm type and the pickup is an optical pickup comprising a laser diode.

### TECHNICAL FIELD OF THE INVENTION

The invention relates to a device comprising a holding fixture and a scanning apparatus with a pickup for reading and/or recording data on a storage medium. The scanning apparatus is in particular a swing arm with an optical pickup and the holding fixture is arranged for providing shock protection within a parking position for the swing arm.

### BACKGROUND OF THE INVENTION

Optical storage media are media in which data are stored in an optically readable manner, for example by means of a pickup comprising a laser for illuminating the optical storage medium and a photo-detector for detecting the reflected light of the laser beam when reading the data.

The storage medium with the highest data capacity is at present the Blu-Ray disc (BD), which allows to store up to 50 GB on a dual layer disc. For reading and writing of a Blu-Ray disc an optical pickup with a laser wavelength of 405 nm is used.

New optical storage media with a super-resolution near-field structure (Super-RENS) offer the possibility to increase the data density of the optical storage medium by a factor of two to four in one dimension in comparison with the Blu-Ray disc. This is possible by using a so-called Super-RENS structure or layer, which is placed above an information layer of the optical storage medium, and which significantly reduces the effective size of a light spot used for reading from or writing to the optical storage medium. In particular for Super-RENS discs, a very high laser power is required for reading or writing of data, which leads to serious heat problems within the pickup, in particular when a compact pickup is desired.

A swing arm is allocated to a storage medium which is designed as a data carrier and is held on a supporting device, the swing arm comprising at its free end a read/write pickup for recording/reading data. Together with the pickup, the swing arm is moved in the form of an arc in a plane extending in parallel to the recording surface of a storage medium which is driven to make a rotational motion, and in a plane extending perpendicularly to this plane, either motion being achieved by a magnetic drive, e.g. a voice coil motor.

If the drive unit for the supporting device is switched off, the storage medium is brought to a standstill and the swing arm is moved to a parking position and located in the position while being protected against shock. This is in particular a requirement, when the drive unit is arranged in a mobile device. In the parking position, the swing arm may be situated on a parking ramp outside of the periphery of the storage medium, such as described in EP-A-1672620, or above a recording-free inner region of the storage medium, as described in U.S. Pat. No. 6,005,736.

In “Micro thermal design of swing arm type small form factor optical pickup system”, Technical Paper, Microsyst Technol. (2006) 12, pages 1093-1097, Springer Verlag 2006, heat problems of small form factor optical pickup systems of swing arm type are discussed, which use a blue laser diode for applications with the Blue-Ray disc format. Finite element analyses shows that an aluminum swing arm is favorable to keep the temperature of the laser diode within a tolerable limit. But an aluminum swing arm has a much higher weight as compared with a plastic or a carbon fiber swing arm.

### BRIEF SUMMARY OF THE INVENTION

The device according to the present invention comprises a scanning apparatus with a pickup for reading and/or recording data on a storage medium, a holding fixture for providing a parking position for the scanning apparatus, and a drive actuator for a movement of the scanning apparatus, wherein the holding fixture comprises a heat sink for cooling down of the scanning apparatus, in particular of the pickup.

The scanning apparatus comprises advantageously a first contact area and the holding fixture a second contact area, and the first contact area is in contact with the second contact area for providing a heat transfer, when the scanning apparatus is in the parking position.

In a further aspect of the invention, the holding fixture comprises a clamping means providing a contact force for pushing the scanning apparatus with the first contact area onto the second contact area, when the scanning apparatus is in the parking position. The scanning apparatus comprises therefore advantageously a leading edge, for providing a contact region for the clamping means, and the clamping means and/or the leading edge comprises a beveled edge, for pushing the leading edge of the scanning apparatus with the first contact area onto the second contact area, when the clamping means moves over the leading edge in the parking position.

In a further aspect of the invention, the scanning apparatus is a swing arm and the pickup comprises a blue laser diode emitting light with a wavelength of e.g. 405 nm, for reading and/or recording data on an optical disc as the storage medium. Laser diodes, in particular blue laser diodes, have a very low efficiency, and when the laser diode is arranged on a miniaturized low mass swing arm for mobile applications, an efficient cooling for the laser diode is required, because the waste heat of the laser diode is a danger for other optical components being arranged on the swing arm. With the invention therefore an efficient cooling of the laser diode can be provided by utilizing a parking position of the holding fixture for the scanning apparatus, which is in particular already required within mobile devices.

The scanning apparatus can be operated advantageously in an intermittent operation, in with the scanning apparatus reads or records data on a storage medium for defined time intervals, and cyclically moves to the parking position for cooling down the pickup and therefore the laser diode.

### BRIEF DESCRIPTION OF THE DRAWINGS

Preferred embodiments of the invention are explained now in more detail below by way of example with reference to schematic drawings, which show:

FIG. 1 a scanning apparatus comprising a swing arm for scanning of an optical storage medium in a perspective top view;

FIG. 2 the swing arm as shown in FIG. 1 in a perspective bottom view;

FIG. 3 the scanning apparatus of FIG. 1 in a cross section;

FIGS. 4a, 4b a first embodiment of the invention with a swing arm and a holding fixture comprising a rotatable clamping means;

FIGS. 5a, 5b a second embodiment of the invention with a swing arm and a holding fixture comprising a first clamping means movable in a radial direction;

FIGS. 6a, 6b a third embodiment of the invention with a swing arm and a holding fixture comprising a second clamping means movable in a radial direction; and

FIG. 7 a fourth embodiment of the invention with a swing arm and a holding fixture comprising a ramp.

### DESCRIPTION OF PREFERRED EMBODIMENTS

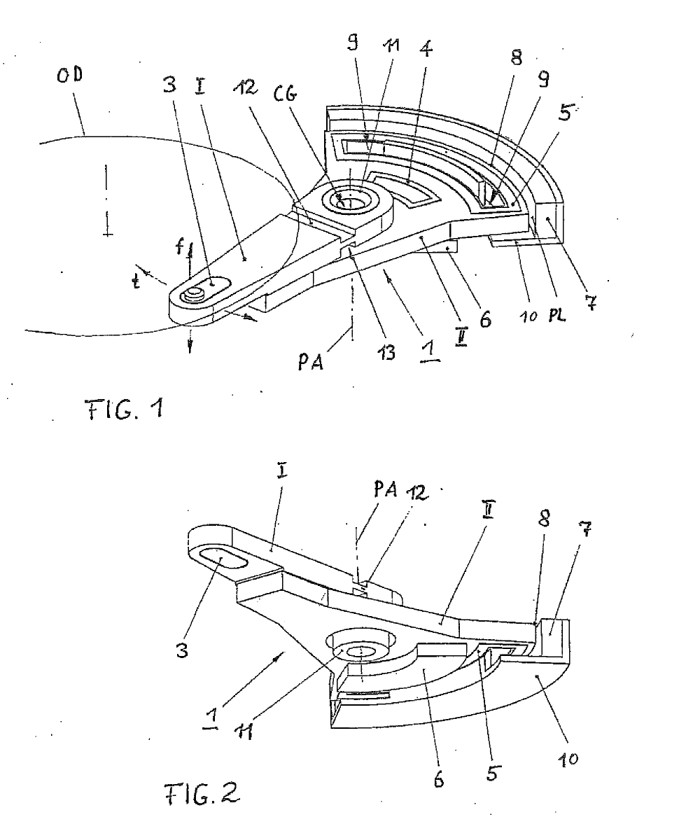

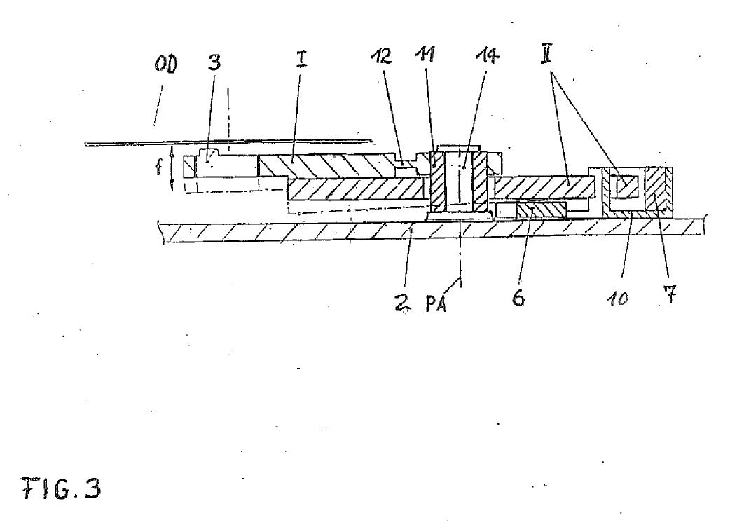

FIGS. 1 and 2 show a scanning apparatus with a swing arm for scanning an optical disc, the swing arm actuator comprising a torsionally stiff swing arm 1 which is designed in the form of a two-arm lever and, in its center of gravity CG between the lever arms I and II, is mounted to a support 2, FIG. 3, such that it can be swiveled in a pivot bearing about a pivot axis PA extending perpendicularly to the swing arm 1. At its end side, the lever arm I supports an optical pickup 3 having a focus lens. Two printed coil arrangements 4 and 5, which are operably magnetically connected to magnets 6 and 7, are arranged on the other lever arm II, the magnets 6 and 7 being permanently attached to the support and being allocated to the coil arrangements 4 and 5, the coil arrangements 4 and 5 forming magnetic drives for the swing arm with these magnets 6 and 7. OD indicates an optical disc to which the pickup 3 is allocated.

The lever arm II, which is preferably at least partly based on PCB-material, comprises an edge region 8 extending coaxially in relation to the pivot axis PA and comprising a coaxially designed recess 9 spaced apart from the edge region 8, the recess 9 being surrounded by a printed coil 5, which is in particular a so-called fine print pattern coil 5 with several layers, for example 6 layers, integrated in the lever arm II. A leg of a U-shaped yoke 10 which is connected to the magnet 7 engages in the recess 9, wherein the magnet 7 itself coaxially encloses the edge region 8 at the latter's outside with play PL. The magnetic drive thus formed causes the swing arm 1 to move perpendicularly to the pivot plane in a focusing direction f.

In the region between the first magnetic drive and the pivot axis PA, the magnet 6 having the shape of a ring section and being permanently attached to the support is arranged coaxially in relation to the pivot axis PA and spaced apart from the lever arm I. One ore more coils 4 corresponding to the magnet 6 and adjusted to the coaxially curved design thereof are allocated to the magnet 6. These coils are also manufactured for example as printed coils or so-called fine print pattern coils with several layers, for example 6 layers, integrated in the lever arm II. The second magnetic drive formed with these coils 4 and the magnet 6 serves to initiate a swivel motion of the swing arm 1 about the pivot axis PA, in tracking direction, and radially in relation to the optical disc OD.

The lever arm I supporting the pickup 3 is connected non-rotatably to a bearing bushing 11 and comprises an elastically bendable region 12 to initiate a motion of the head 3 in focusing direction f perpendicularly to the pivot plane. In the region between the pickup 3 and the region 12, the lever arm II is securely connected to the lever arm I, the lever arm II being exclusively held in that region and, thus, up to its edge region 8 being freely suspended on that side of the bendable region 12 that is facing away from the pickup 3, as shown also in FIG. 3.

Due to a groove 13 incorporated in the bottom side and the top side of the lever arm I, the region 12 is considerably reduced as compared with the thickness of the lever arm I while being designed in its thickness such that the head-sided part of the otherwise rigid lever arm I is moved in focusing direction f once the lever arm II is loaded by the first magnetic drive which is formed with the magnet 7. The secure connection of the two lever arms I and II is also used to initiate the swivel motion of the lever arm I about the pivot axis PA and, thus, to initiate a swivel motion of the entire swing arm 1, wherein the swivel motion of the lever arm I about the pivot axis PA results from a swivel motion of the lever arm II caused by the second magnetic drive formed with the magnet 6.

FIG. 3 shows the arrangement and mounting of the swing arm 1 to the support 2. A pivot pin 14 is permanently arranged at the support 2, with the swing arm 1 being mounted to the pivot pin 14 such that it can be pivoted with the bearing bushing 11. The optical disc OD which is allocated to the pickup 3 is arranged in parallel therewith. A swivel motion of the swing arm 1 about the pivot axis PA causes the pickup 3 to be moved in radial direction relative to the disc OD, the tracking direction. Focusing of a specific point on the disc OD is achieved through a motion of the lever arm II and, thus, of the pickup 3 in focusing direction f and perpendicularly to the tracking direction t, as shown also in FIG. 1.

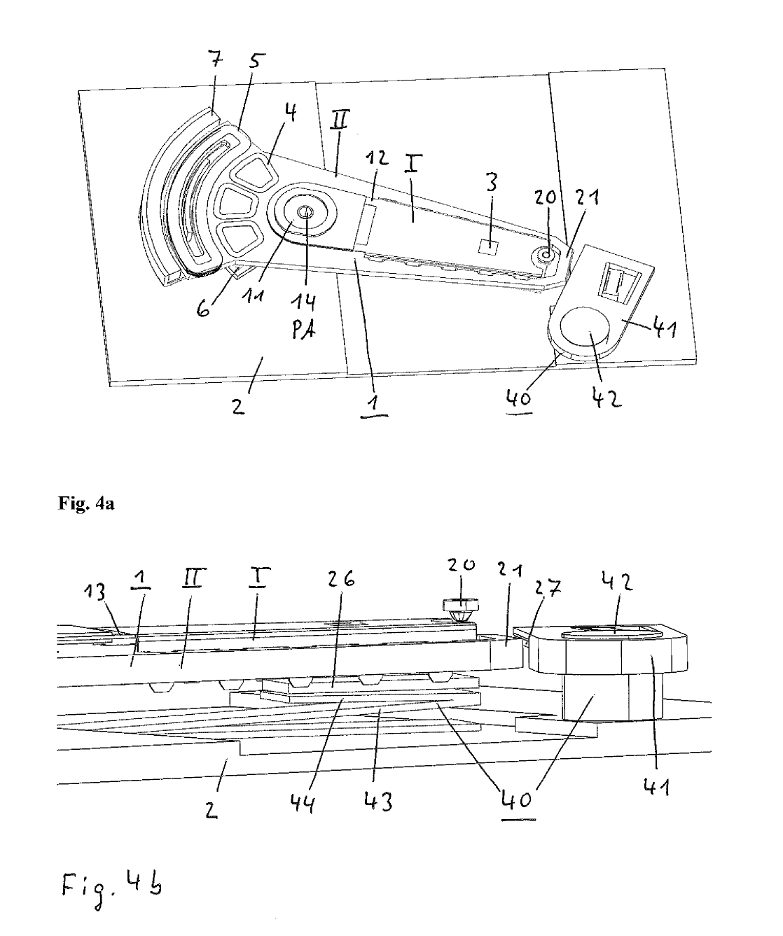

In FIG. 4a a swing arm is shown in a perspective top view comprising a first lever arm I and a second lever arm II, in correspondence as described before with regard to FIGS. 1-3. The lever arm II comprises on one end first coils 4 for providing a tracking movement and a second coil 5, which constitute together with magnets arranged on the support 2 magnetic actuators for providing a tracking movement and a focus movement as described before. On the other end of the second lever arm II, the first lever arm I is fixed, which moves therefore in accordance with the second lever arm II. The first lever arm I carries in particular an optical pickup 3 comprising an objective lens 20, for recording and/or reading data on an optical disc.

The part of the first lever arm I, which carries the pickup 3, is connected via the bendable region 12 with the part of the first lever arm I, which is connected via the bearing bushing 11 and the pivot pin 14 with the support 2, the pivot pin 14 defining a pivot axis PA for the tracking movement, and the bendable region 12 defining a second pivot axis for the focus movement. The support 2 is in particular a metallic base plate or a partly metallic base plate.

On the support 2 further a holding fixture 40 is arranged, for securing the swing arm 1 in a parking position. The holding fixture 40 comprises a clamping means, a turning lever 41, which is arranged on a pivot axis 42. The second lever arm II comprises a leading edge 21, which extends over the first lever arm I. When the swing arm 1 is moved to the parking position by the tracking magnetic drive 4, 6, the turning lever 41 moves over the leading edge 21 for pushing down the swing arm 1 onto a heat sink, as shown in FIG. 4b.

FIG. 4b shows the swing arm 1, the holding fixture 40 and the base plate 2 in a side view, when the swing arm 1 is moved to the parking position. The heat sink of the holding fixture 40 comprises a “Z” like spring 43 with a contact area 44, onto which the swing arm 1 can be pressed by the turning lever 41 in the parking position by rotating the turning lever 41. The turning lever 41 can be rotated for example by means of a magnetic actuator, not shown.

The second lever arm II comprises a contact area 26, which is in thermal contact with a laser diode of the pickup arranged on the lever arm I, for providing an efficient heat transfer from the laser diode to the contact area 26. The “Z” like spring 43 comprises a second contact area 44, heaving about the same size as the first contact area 26, and which is connected in this embodiment by means of the “Z” like spring 43 to the support 2. The first contact area 26 and the second the contact area 44 are provided for example by copper plates.

The “Z” like spring 43 is arranged on the support 2 such, that when the swing arm 1 is moved to the parking position, the second contact area 44 faces to the first contact area 26 and when the turning lever 41 pushes down the swing arm 1 in the parking position, the first contact area 26 moves down onto the second contact area 44 and loads the “Z” like spring 43, the spring 43 providing a counterforce, for providing an efficient heat transfer from the first contact area 26 to the second contact area 44 and then via the spring 43 to the support 2. The parking position of the swing arm 1 is therefore used at the same time as a cooling position for the pickup, when the swing arm 1 is secured by the turning lever 41.

The turning lever 41 comprises in particular a beveled edge 27 at the end being in contact with the leading edge 21, so that the turning lever 41 moves smoothly over the leading edge 21, when securing the swing arm 1 in the parking position. The “Z” like spring 43 consists of an elastic metal with flexible ends, for providing a resilient movement of the second contact area 44, so that the first contact area 26 is in full contact with the second contact area 44 for a good heat transfer, when the swing arm 1 is pushed down by the turning lever 41 in the parking position. The first contact area 26 and the second contact area 44 are in particular metal plates having good heat conductivity.

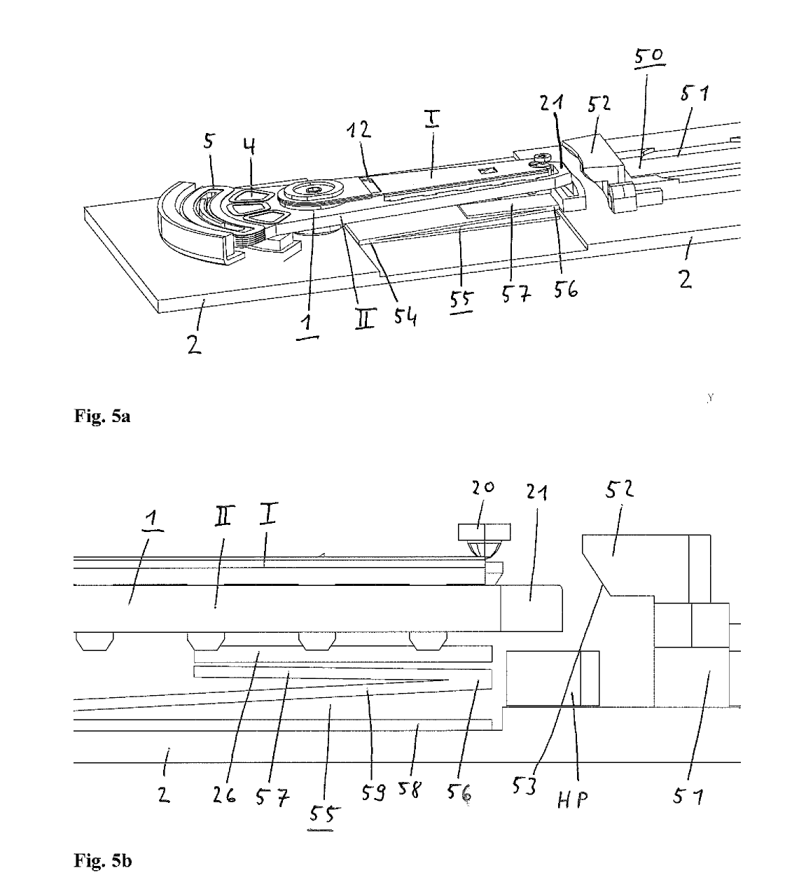

In FIGS. 5a, 5b a second embodiment of the invention is shown, comprising a swing arm 1 being arranged on a support 2, as explained before with regard to FIGS. 4a, 4b. The holding fixture 50 of this embodiment comprises a moveable clamp 52, which is arranged via a sledge 51 on the support 2. The sledge 51 provides a movement of the clamp 52 in the direction of the pivot axis PA, as defined by the pivot pin 14. The movement of the sledge 51 may be provided for example by a magnetic actuator, not shown.

When the clamp 52 is moved by the sledge 51 in the direction of the pivot pin 14, the clamp 52 engages with the leading edge 21 of the swing arm 1 and pushes the second lever arm II with its contact area 26, shown in FIG. 5b, onto a “Z”-like spring 55 for securing the swing arm 1 in a parking position. The “Z” like spring 55 comprises a second contact area 57 facing the contact area 26 for providing an efficient heat transfer from the pickup of the swing arm 1 to the support 2.

In this embodiment, the clamp 52 has a width in tangential direction of the swing arm 1 extending such, that all tracking positions of the swing arm 1 can be covered, for providing a parking position for the swing arm 1 corresponding to all tracking positions. The contact area 57 of the spring 55 extents correspondingly also in tracking direction, to cover all tracking positions of the swing arm 1. Therefore, the swing arm 1 has not to be moved to a special parking position, but all tracking positions can be used for a parking position and no tracking movement of the swing arm 1 is necessary, for securing the swing arm 1 and for providing a heat transfer between the pickup and the support 2.

To avoid any contact between the optical disc and the clamp 52, the height of the clamp 52 with regard to the support 2 is similar to height of the second lever arm II with regard to the support 2, and in particular does not extend over the objective lens 20, when the swing arm 1 is in operation, for not touching the optical disc, when the clamp 52 moves in the direction of the leading edge 21 for securing the swing arm 1 in the parking position. The embodiment as shown in FIGS. 5a, 5b allows therefore in particular rapid cooling cycles with little energy consumption, for cooling down of the pickup, when reading and/or recording data on the optical disc.

In FIG. 5b, in an enlarged side view a part of the sledge 51 is shown together with the clamp 52, the spring 55 and the ends of the lever arm II and the lever arm I facing away from the pivot axis PA. When the clamp 52 is moved by the sledge 51 in the direction of the pivot pin 14, the contact area 26 of the swing arm 1 is pushed in the direction of the support 2 by the clamp 52, when the clamp 52 slides over the leading edge 21. The clamp 52 may have a beveled edge 53, in addition also the leading edge 21, for providing a smooth sliding of the clamp 52 over the leading edge 21. The holding fixture 50 may comprise in addition a holding plate HP, on which the end of the lever arm II is placed in the parking position, for providing a secure parking.

The “Z” like spring 55 consists in this embodiment of an upper plate 57 representing the contact area 57, a lower plate 58 being fixed to the support 2 and a middle plate 59, which is attached with one end 56 to the upper plate 57, and with the other end 54, shown in FIG. 5a, to the lower plate 58. But other spring arrangements may be used accordingly. In particular the ends 54, 56 of plate 59 connected to plates 57 and 56 are bendable regions for providing a full contact between the contact areas 26, 57, to allow an efficient heat transfer between the base plate 26 and the support 2. As a material for the spring 25 for example spring bronze may be used.

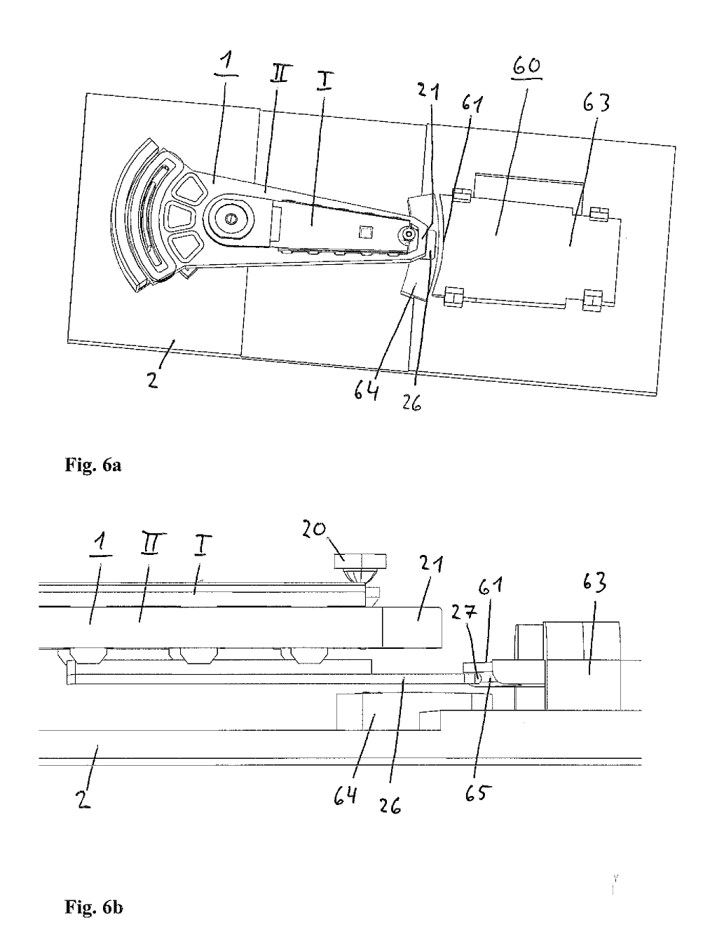

A third embodiment is shown in FIGS. 6a, 6b comprising a holding fixture 60, similar to the second embodiment shown in FIGS. 5a, 5b. The swing arm 1 of this embodiment is designed similar to the embodiments described before, but here the contact area 26, a metal plate of the swing arm 1, extends over the leading edge 21 of the lever arm II. The holding fixture 60 comprises a sledge 63, which moves a contact slider 61 over the contact area 26, for providing a parking position, in which the swing arm 1 is secured. The contact area 26 of the swing arm 1 is then placed on a cooling pad 64 for cooling down of the pickup of the swing arm 1.

In FIG. 6b, the holding fixture 60 and the front end of the swing arm 1 are shown in more detail in a side view. The contact slider 61 comprises in particular a leading edge 65, for sliding in a smooth movement over a leading edge 27 of the contact area 26 for pushing down the contact area 26 onto the cooling pad 64. The cooling pad 64 comprises in particular a contact area facing to the contact area 26 for providing an efficient heat transfer. On this cooling pad 64 the contact area 26 is placed in the parking position. The holding fixture 60 provides therefore also in this embodiment a secure parking position, in which the heat can be dissipated away effectively from the pickup of the swing arm 1 to the support 2.

The cooling pad 64 and the contact slider 61 in particular have a width such for covering all tracking positions of the swing arm 1, so that the swing arm 1 can be secured under all operating conditions, respectively tracking positions, in a parking position, without requiring a tracking movement for locating the swing arm 1 in the parking position, as required for the embodiment shown in FIGS. 4a, 4b. The cooling pad 64 can be considered as an alternative to the “Z” like spring, as explained before with regard to the first and the second embodiment.

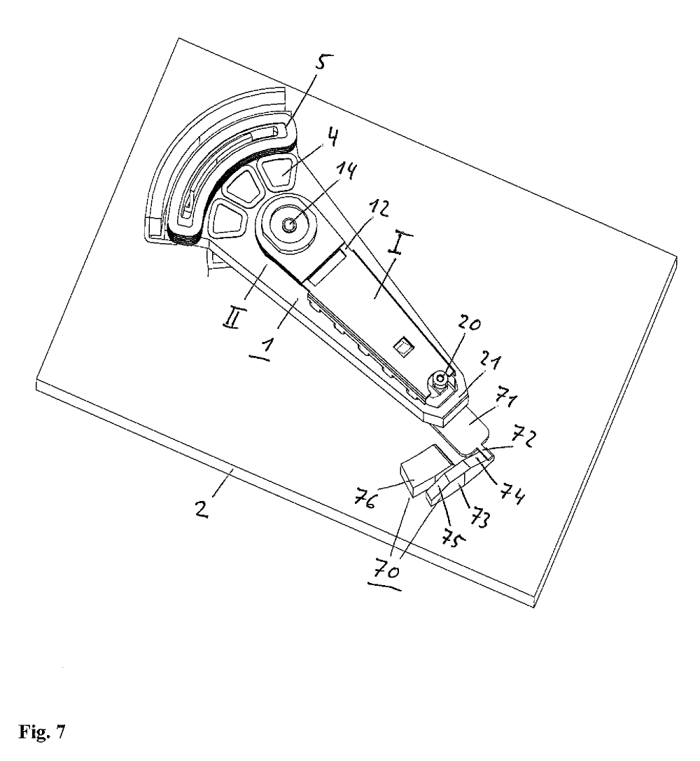

In FIG. 7 a further embodiment of the invention is shown comprising a swing arm 1 attached on a support 2, which comprises a metal plate 71 with a contact area, which extends over the leading edge 21 of the second lever arm II. In contrast to the embodiment shown in FIGS. 6a, 6b, the metal plate 71 comprises in addition a guiding pin 72 at the side of the contact pin 71 facing away from the pivot pin 14.

The holding fixture 70 of this embodiment does not include a clamping means, but a ramp 73 with an up-ramping part 74 and a down-ramping part 75, the ramp 73 being arranged such on the support 2, that the guiding pin 72 moves over the ramp 73 to the down-ramping part 75, when the swing arm 1 is moved to the parking position. In the parking position, the metal plate 71 rests with its contact area on a contact area of a cooling pad 76. Contact plate 71 and cooling pad 76 have contact areas similar in size and facing to each other, for providing an efficient heat transfer.

To move the swing arm to the parking position, a movement is required initiated by the tracking coils 4. The parking position is arranged in particular outside of the operating range of the swing arm 1, so that the lever arm I can be moved in focus direction by the ramp 73, without touching the optical disc, so that the objective lens 20 as well as the optical disc cannot be destroyed.

Because the swing arm 1 is moved with a lever arm I in the direction of the optical disc, the bendable region 12 provides a counter force, which pushes the contact plate 71 onto the contact pad 76, so that no clamping means is necessary, as required for the embodiments shown before.

Alternatively, the contact pad 76 may be replaced by a “Z” like spring, as described already before.

The embodiments as described before provide therefore an efficient cooling down of the swing arm, hence of the pickup, in the parking position. In particular, when providing sufficiently large first and second contact areas, a corresponding fast cooling down time can be provided for a cyclic operation of the swing arm. No heat sink is required on the swing arm, and a lightweight plastic swing arm, e.g. a carbon fiber swing arm, can be used as the scanning apparatus. Only an efficient heat transfer is required between the laser diode of the optical pickup and the first contact area within the swing arm, which can be made for example by using copper connection parts between the laser diode and the first contact area.

The parking position can be used therefore in addition for a cyclic operation of the scanning apparatus, for example by using a cycle time of 30 seconds with a switch-on time of the laser diode of 33%. This leads to a switch-off time of 20 seconds of the laser diode, during which the pickup is cooled down in the parking position, and to a switch-on time of 10 seconds. The cyclic operation can be used in particular for reading or writing data with high data rates on a super resolution near-field structure (Super-RENS) disc or other new optical storage media by using a blue laser diode having a sufficient power for triggering the super resolution near-field effect.

The invention allows keeping the optical components of the pickup in a safe temperature range for a reliable operation of the scanning apparatus, e.g. a swing arm. No heat sinks or any other cooling elements are required, because a support is used, in particular a metallic base plate or a partly metallic base plate, which has either a comparatively high mass with a respective large heat capacity and heat radiation, or which can transfer the heat of the scanning apparatus to the housing of the device.

The device according to the invention can be used in particular for mobile applications, as for example video players, audio players or game consoles. But also other embodiments of the invention can be made by a person skilled in the art without departing from the spirit and scope of the present invention. The invention is in particular not restricted to swing arm arrangements, but can be utilized also for devices comprising other scanning apparatuses. The invention resides therefore in the claims herein after appended.

1. Device comprising
a scanning apparatus with a pickup for reading and/or recording data on a storage medium,
a holding fixture for providing a parking position for the scanning apparatus, and
a drive actuator for a movement of the scanning apparatus, wherein the holding fixture comprises a heat sink for cooling down the pickup.

2. The device of claim 1, wherein the scanning apparatus comprises a first contact area and the holding fixture comprises a second contact area, and that the first contact area is in contact with the second contact area for providing a heat transfer, when the scanning apparatus is in the parking position.

3. The device of claim 2, wherein the holding fixture comprises a clamping means for providing a contact force for pushing the scanning apparatus with the first contact area onto the second contact area, when the scanning apparatus is in the parking position.

4. The device of claim 3, wherein the scanning apparatus comprises a leading edge for providing contact with the clamping means in the parking position.

5. The device of claim 4, wherein the clamping means and/or the leading edge comprises a beveled edge, for pushing the leading edge with the first contact area onto the second contact area, when the scanning apparatus is in the parking position.

6. The device of claim 5, wherein the clamping means is arranged on an axis and comprises a clamping actuator for providing a swivel movement for securing the scanning apparatus in the parking position.

7. The device of claim 5, wherein the clamping means is arranged on a sledge for providing a movement in the direction of the scanning apparatus for securing the scanning apparatus in the parking position.

8. The device of claim 5, wherein the holding fixture comprises a ramp with an up-ramping section and a down ramping section.

9. The device of claim 5, wherein the second contact area is provided by a “Z” like resilient spring providing a counter force or the second contact area is provided by a contact pad, the resilient spring respectively the contact pad being arranged on a support, on which the scanning apparatus is arranged.

10. The device of one claim 5, wherein the scanning apparatus is of a swing arm type, the drive actuator is a magnetic drive actuator, and wherein the pickup is an optical pickup comprising a laser diode for reading and/or recording data on an optical disc as the storage medium.

11. The device of claim 10, wherein the parking position is utilized for a cyclic operation of the laser diode with a switch-on time of the laser diode for reading or writing data on the storage medium, and with a switch-off time of the laser diode, during which the pickup is cooled down in the parking position.

12. The device of claim 11, wherein the laser diode is a blue laser diode operating in a power range for reading or writing data on super resolution near-field structure disc.

13. Device comprising
a scanning apparatus with a pickup for reading and/or recording data on a storage medium,
the scanning apparatus being of a swing arm type with a drive actuator being a magnetic drive actuator, and wherein the pickup is an optical pickup comprising a laser diode for reading and/or recording data on the storage medium,
a holding fixture for providing a parking position for the scanning apparatus, and
a drive actuator for a movement of the scanning apparatus, wherein the holding fixture comprises a heat sink for cooling down the pickup,
the scanning apparatus comprises a first contact area and the holding fixture comprises a second contact area, and wherein the first contact area is in contact with the second contact area for providing a heat transfer, when the scanning apparatus is in the parking position.

14. The device of claim 13, wherein the parking position is utilized for a cyclic operation of the laser diode with a switch-on time of the laser diode for reading or writing data on the storage medium, and with a switch-off time of the laser diode, during which the pickup is cooled down in the parking position.

15. The device of claim 14, wherein the holding fixture comprises a clamping means for providing a contact force for pushing the scanning apparatus with the first contact area onto the second contact area, when the scanning apparatus is in the parking position.

16. The device of claim 15, wherein the scanning apparatus comprises a leading edge for providing contact with the clamping means in the parking position.

17. The device of claim 16, wherein the clamping means and/or the leading edge comprises a beveled edge, for pushing the leading edge with the first contact area onto the second contact area, when the scanning apparatus is in the parking position.
